(19) United States
(12) Patent Application Publication
(10) Pub. No.: US 2009/0236167 A1
(43) Pub. Date: Sep. 24, 2009

(54) Support frame for auxiliary power unit for a motor vehicle

(75) Inventors: Arthur E. Hirsch, Paris, IL (US); Burl Wayne Tichenor, Avon, IN (US)

Correspondence Address: JAMES RAY & ASSOCIATES, 2640 Pitcairn Road, Monroeville, PA, 15148, US

(73) Assignee: DUNAMIS GROUP, LLC

(21) Appl. No.: 12/077,566

(22) Filed: Mar. 20, 2008

(51) Int. Cl. B60K 25/00; B60K 5/00; B60K 1/00

(52) U.S. Cl. 180/299

(57) ABSTRACT

An auxiliary power system for a long-haul truck includes a first frame which has an auxiliary power unit mounted thereon using elastomeric isolation mounts. A second frame is affixed in a stationary position to an exterior surface of a single longitudinal rail of the vehicle frame. There is a pair of spring elements each operable in a vertical direction and having a first end thereof pivotally connected to a respective side member of the first frame and having a second end thereof pivotally connected to a respective side member of the second frame, whereby the first frame is capable of moving in a vertical plane relative to the second frame for isolating the auxiliary power unit from the effects of road shock and vibration. Elastomeric isolation mounts are also provided for controlling downward movement of the first frame.

### CROSS-REFERENCE TO RELATED APPLICATIONS

This application is related to U.S. Utility patent application Ser. No. 11/386,964 filed on Mar. 22, 2006 and entitled “Auxiliary Power Unit For A Vehicle” and whose teachings are incorporated into this document by reference thereto.

### FIELD OF THE INVENTION

The present invention relates, in general, to auxiliary power units and, more particularly, this invention relates to a support frame for an auxiliary power unit employed on vehicles, such as long-haul trucks and, yet more particularly, the instant invention relates to a support frame for an auxiliary power unit employed on motor vehicles that isolates the auxiliary power unit from the effects of road shock and vibration.

### BACKGROUND OF THE INVENTION

As is generally well known, Auxiliary Power Unit (APU) is employed extensively on motor vehicles such as long-haul trucks to provide electrical power and enable control of the climate environment in the cab when the truck is parked and its engine has been shut-off. It is also well known that APU requires frequent maintenance and servicing and must withstand continuous effects of road shock and vibration experienced during operation of the truck.

Prior to the conception and design of the present invention efforts have been made to improve access to APU during maintenance and servicing and to isolate the APU from effects of road shock and vibration. U.S. Pub. No. 2007/0221431 to Hirsch, the inventor of the present invention, discloses an auxiliary power system for a vehicle that has a frame with two longitudinal beams. The APU is mounted on a support frame that is pivotably mounted to the vehicle frame to permit pivoting in a vertical plane. The support frame further includes a suspension system at an intermediate location between the pivot mount and the APU to help isolate the APU from the effects of road vibration. The APU itself is mounted on rollers so that the APU can be slid out of its housing and be supported by open housing door for access and/or removal. While such system has alleviated difficulties associated with presently employed APUs, it has been found that the support frame encroaches on vehicle's components mounted within the vehicle frame. It has been further found that arrangement enabling sliding movement of the APU increases manufacturing costs.

Therefore, there is a continuing need for an improved support frame to mount APU to the vehicle frame that provides ease of access to APU during maintenance, decreases manufacturing costs and isolates APU from undesirable effects of road shock and vibration.

### SUMMARY OF THE INVENTION

According to one aspect, the invention provides an auxiliary power system for a motor vehicle. The auxiliary power system includes a first frame. An auxiliary power unit is mounted on the first frame. A second frame is provided and is mounted in a stationary position to a predetermined portion of such motor vehicle. There is means which is coupled to the first and second frames for enabling movement of the first frame in a vertical plane relative to the second frame to isolate the auxiliary power unit from the effects of road shock and vibration.

According to another aspect of the invention there is provided, in combination with an auxiliary power unit for a vehicle, a frame assembly for isolating the auxiliary power unit from the effects of road shock and vibration. The frame assembly includes a first frame. The first frame has a pair of vertically disposed side members, each having a predetermined shape and inwardly and horizontally disposed bottom flange. A first cross member is secured at each end thereof to a respective top end of each side member. A second cross member is secured at each end thereof to a respective side member intermediate ends thereof. A base plate is provided and the auxiliary powered unit is affixed thereto. Elastomeric isolation mounts are employed for attaching the base plate to the flanges of the side members. The frame assembly also includes a second frame. The second frame has a pair of side members each having a first vertically disposed portion thereof positioned coplanar in abutting engagement with the longitudinal rail of the vehicle and a second vertically disposed portion extending outwardly from and generally perpendicular to the first portion. A pair of are apertures formed through the first vertical portion and are spaced in a vertical direction for enabling attachment of the second frame to the side rail with fasteners. A cross member is rigidly secured at each end thereof to a respective side member of the second frame intermediate ends thereof. The frame assembly additionally includes a pair of spring elements each operable in a vertical direction and having a first end thereof pivotally connected to a respective side member of the first frame and having a second end thereof pivotally connected to a respective side member of the second frame. The spring elements enable the first frame to move in a vertical plane relative to the second frame for isolating the auxiliary power unit from the effects of road shock and vibration. Finally, the support frame includes a pair of elastomeric isolation mounts operably secured to the cross member of the second frame for abuttingly engaging the second cross member of the first frame and for terminating a downward movement of the first frame after termination of the effects of road shock and vibration.

According to yet another embodiment, the invention provides an auxiliary power system for a vehicle. The auxiliary power system includes an auxiliary power unit and a suspension means mounted to a single longitudinal rail of the vehicle frame and securely receiving the auxiliary power unit, whereby the auxiliary power unit is allowed to move in a vertical plane relative to the longitudinal rail of the vehicle for withstanding the effects of road shock and vibration.

### OBJECTS OF THE INVENTION

It is, therefore, one of the primary objects of the present invention to provide a support frame for APU employed on motor vehicles, such as long-haul trucks.

Another object of the present invention is to provide an APU support frame that provides ease of access to APU for maintenance and replacement.

Yet another object of the present invention is to provide an APU support frame that isolates the APU from undesirable effects of road shock and vibration.

A further object of the present invention is to provide an APU support frame that enables movement of the APU in a vertical plane.

Yet a further object of the present invention is to provide an APU support frame that compensates for noise and vibration generated by APU during its operation.

An additional object of the present invention is to provide an APU support frame that is cost effective to manufacture.

Another object of the present invention is to provide an APU support frame that is simple to install.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a side view of a long-hole truck with an auxiliary power unit system of the present invention;

FIG. 2 is a front isometric view of the auxiliary power unit system of the present invention; and

FIG. 3 is a front isometric view of the support frame employed within the auxiliary power unit system and constructed in accordance with a presently preferred embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

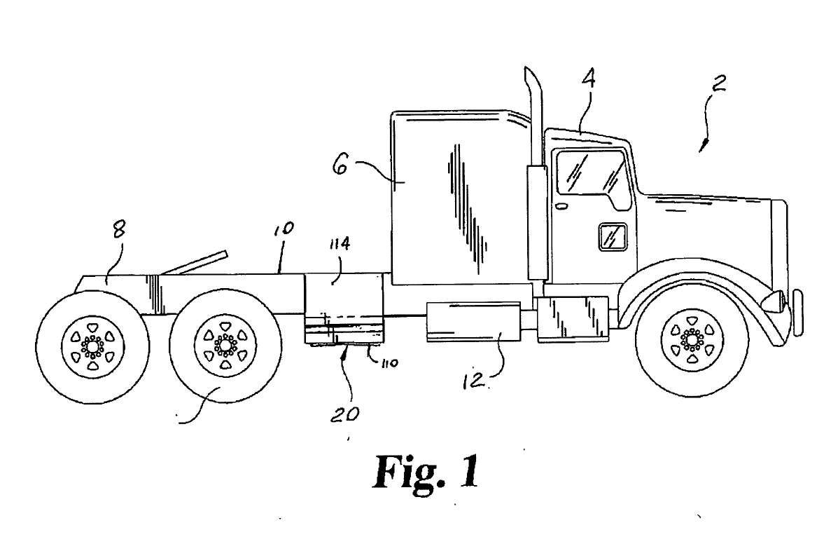

The best mode for carrying out the invention is presented in terms of its presently preferred embodiment, herein depicted within FIGS. 1 through 3. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Reference is now made to FIG. 1 that depicts an environment wherein the support frame assembly, generally designated as 20, of the present invention is employed. Particularly shown is a long-haul truck 2. The truck 2 includes a cab 4 to which a sleeper cabin 6 may be connected. The truck 2 also includes a truck frame 8 that supports the cab 4 and sleeper cabin 6, as well as a fuel tank 12. The truck frame 8 is generally formed by a pair of longitudinally disposed rails 10, only one of which is shown in FIGS. 1-3. The auxiliary power unit (APU) system 14 of the present invention is configured to be supported by only one existing rail 10, preferably between the fuel tank 12 and the wheels 16.

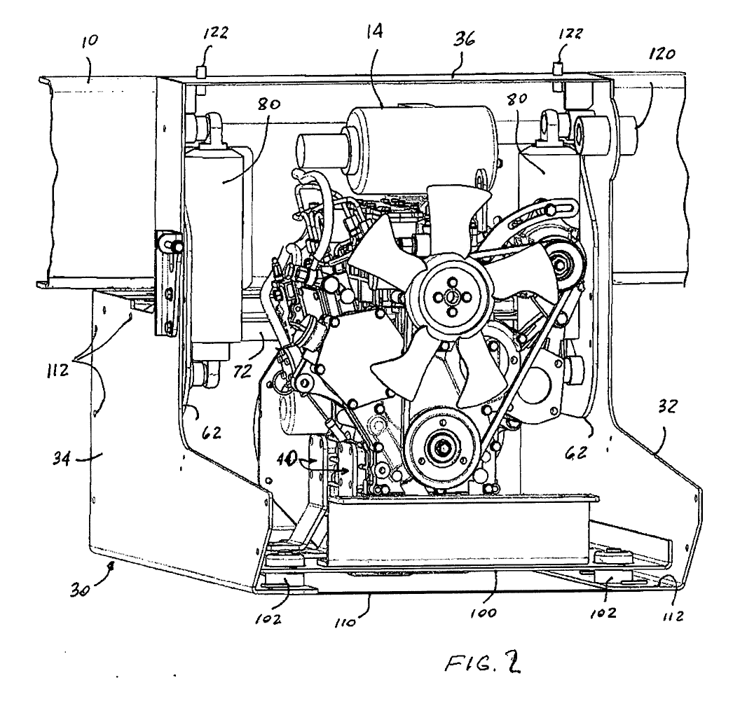

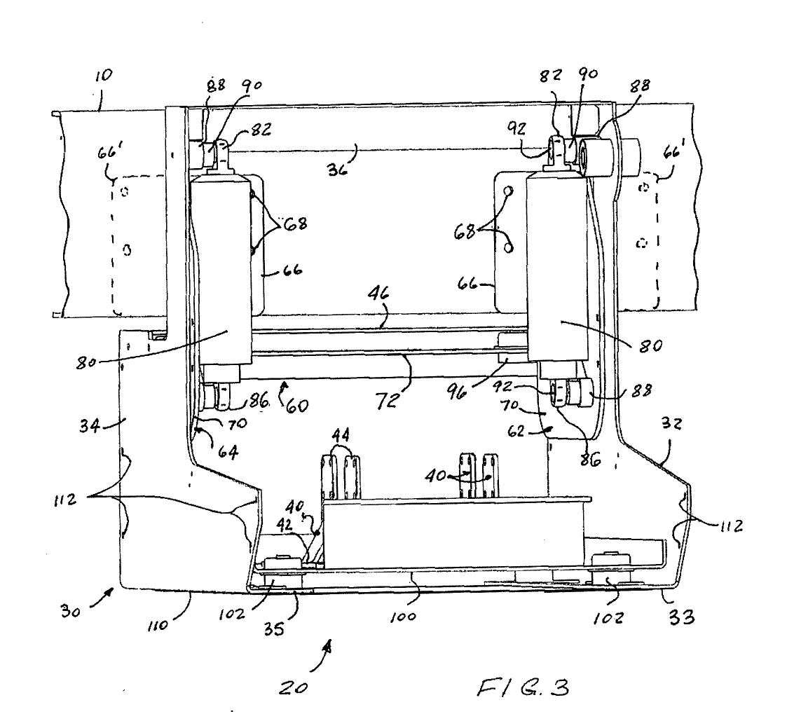

The support frame assembly 20, constructed in accordance with a presently preferred embodiment of the invention, is best shown in FIGS. 2-3. The support frame assembly 20 includes a first frame, generally designated as 30, on which is the APU system 14 is mounted. Specifically, the first frame 30 includes a first vertically disposed plate-like side member 32 having an inwardly and horizontally disposed flange 33 and a second vertically disposed plate-like side member 34 having an inwardly and horizontally disposed flange 35. Preferably, the vertically disposed portions of the side members 32 and 34 have identical shape except for the orientation of the flanges 33 and 35. The APU system 14 is then operably supported on such flanges 33 and 35. A first cross member 36, preferably having an L-cross-section is secured at each end thereof to a respective top end of the side member 32, 34. The manner in which the APU system 14 is secured to the flanges 33 and 35 depends on the construction of the specific APU system 14. Exemplary APU system 14 of FIG. 2 requires a plurality of mounting brackets 40 having a horizontally disposed first portion 42 secured, with fasteners (not shown) to a respective flange 33, 35 and having a vertically disposed second portion 44 secured, with fasteners (not shown) to a bottom end of the APU system 14. It will be understood that APU system 14 of a different construction will require different securing arrangement either directly to the flanges 33, 35 or through the use of mounting brackets. The final essential element of the first frame 30 is a second cross member 46 secured at each end thereof to a respective side member 32, 34 intermediate ends thereof.

There is also provided a second frame, generally designated as 60, which is mounted in a stationary position on the truck 2. The second side frame 60 includes a vertically disposed first side member 62 and a vertically disposed second side member 64. Each side member 62, 64 has a first plate-like portion 66 thereof positioned in abutting engagement with an exterior surface of the longitudinal rail 10 of the truck frame 8. A pair of apertures 68 are formed through such first portion 66 in order to secure the side member 62, 64 to the longitudinal rail 10 with the use of fasteners (not shown). A second plate-like portion 70 of each side member 62, 64 extends outwardly from and generally perpendicular to first portion 66. The side members 62 and 64 are generally identical except for orientation of the first portion 66. Although the first portion 66 of each side members 62 and 64 has been illustrated in FIGS. 2-3 as inwardly formed, it is also within the scope of the present invention to outwardly form such first portion 66, as shown by reference character 66′ in FIG. 3. A cross member 72 is rigidly secured at each end thereof to a respective side member 62, 64 intermediate ends thereof.

The present invention also provides means coupled to the first and second frames, 30 and 60 respectively, for isolating the APU system 14 from the effects of road shock and vibration, whereby the first frame 30 is allowed to pivot and move, both in a vertical plane, relative to the second frame 60 and further relative to the truck frame 8. In order to provide for such vertically pivotal movement, the isolating means includes a pair of spring elements 80. Each spring element 80 is operable in a vertical direction and has a first end 82 thereof pivotally connected to the side member 32, 34 of the first frame 30 at a first pivot 84. The spring element 80 also has a second end 86 thereof pivotally connected to a respective side member 62, 64 of the second frame 60 at a second pivot 88. The spring element 80 may be a conventional shock absorber, as shown in FIGS. 2-3 or an elastomeric air spring which is not shown but which is well known in the art. The first and second pivots 84 and 88 are preferably identical and being formed by a pin 90 rigidly secured to the respective side member 32, 34, 62 or 64 and cooperating with a simple aperture 92 formed through each of the first and second ends, 82 and 86 respectively, of the spring element 80. However, it is within the scope of the present invention to form the aperture 92 through the respective side member 32, 34, 62 or 64 and adapt the first and second ends, 82 and 86 respectively, with the pin 90. It is also within the scope of the present invention to employ other well known pivot arrangements.

In use, the APU system 14 is secured to the flanges 33, 35 of the first frame 30. The first frame 30 is then secured to the longitudinal rail 10 of the truck frame 8. During operation, the shocks experienced by the truck 2 from road surface impurities are transferred to the support frame 20 through the truck frame 8. Upon receiving such effects of road shock and vibration, the first frame 30 pivotally moves in a vertical plane relative to the second frame 60 and to the truck frame 8 since the spring elements 80 are positioned toward the top of the frame assembly 20. Depending on whether the truck has encountered a cavity or a bump in a road surface, the bottom right-hand corner of the first frame 30, as viewed in FIGS. 2-3, will move away or toward the truck frame 8. When the effect of the road shock subside, the first frame 30 will pivotally return to its normal position and such movement will be cushioned or dampened by the spring elements 80.

The presently preferred material of the first and second frames, 30 and 60 respectively, is metal and, more particularly, such as steel. The presently preferred method of securing various components of each frame therebetween is by a welding process, although use of fasteners is also contemplated.

It will be appreciated that the APU system 14 is essentially suspended, by way of the support frame 20, from the exterior surface of a single longitudinal rail 10 and is allowed to move in a vertical plane relative to the longitudinal rail 10 for withstanding effects of road shock and vibration.

The shape of the side members 32, 34 of the first frame 30 is predetermined based on the shape and size of the APU system 14 to maximize position of such APU system 14 external to the longitudinal rail 10 of the truck frame 8 but within the required space envelop, provide required clearance in a vertical direction from the road surface and minimize encroachment of the support frame 20 internal of the longitudinal rail 10.

To further cushion or dampen the pivotal movement of the first frame 30 and to prevent stopping such downward movement by way of spring elements 80, the present invention contemplates a stop means, for example, such as a pair of stop members 96, only one of which is shown in FIG. 3. The stop members 96 are preferably attached to the cross member 72 of the second frame 60 and abut the bottom surface of the second cross member 46 of the first frame 30 for controlling pivotal movement of the first frame 30. Preferably, such stop members 96 are manufactured from an elastomeric material, such as hard rubber. It is further presently preferred to employ a well known elastomeric isolation mounts of the type as manufactured by Corry Rubber Corporation of Cory, Pa. Advantageously, such elastomeric isolation mounts further provide shock and vibration attenuation between the first frame 30 and the second frame 60.

It will be understood that the spring elements 80 and the isolating mounts 96 are selected to withstand the frequency generated due to effects of road shock and vibration and prevent the support frame 20 and the APU system 14 from resonating at such frequency.

It is also within the scope of the present invention to isolate the support frame 20 from the noise and vibration generated by operating APU system 14. Accordingly, the present invention provides a base plate 100 which has the APU system 14 secured thereon by way of mounting brackets 40 and a plurality of elastomeric isolation mounts 102 disposed essentially between the base plate 100 and the flanges 33, 35 of the first frame 30. It would be appreciated that the elastomeric isolation mounts 102 may be identical to the elastomeric isolation mounts used as stop members 96.

Although the present invention has been shown in terms of the second frame 60 being disposed within the first frame 30 wherein a portion of the each side member 32, 34 of the first frame 30 is disposed coplanar with the second vertically disposed portion 70 of the second frame 60, it will be apparent to those skilled in the art, that the side members 62, 64 of the second frame 60 may be positioned external to the respective side members 32, 34 of the first frame 30.

Furthermore, various cover members may be provided for enclosing the APU system 14 within the support frame 20. For the sake of clarity a bottom cover 110 and a front cover 114 are shown in FIG. 1, while only the bottom cover member 110 is shown in FIGS. 2-3. The covers 110, 114 may be simply attached by way of fasteners (not shown) and apertures 112 formed in the side members 32, 34 of the first frame 30.

It will be also appreciated that the support frame 30 is adapted with air communication means such as a pipes 120 and 122 for proper operation of the APU system 14.

Also, the spring elements 80 may be provided as hydraulic or pneumatic cylinders.

Furthermore, the present invention contemplates that the isolating mounts 96 may be replaced with a second pair of spring elements 80 also operable in a vertical direction. When four spring elements 80 are employed, the first frame 30 will move generally linear in a vertical plane, particularly, when one end of each spring element has a non-pivotal connection to a respective frame member.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An auxiliary power system for a motor vehicle, said auxiliary power system comprising:
(a) a first frame;
(b) an auxiliary power unit capable of generating electrical power and providing cooling and heating environmental effects to operator and occupant of the motor vehicle, said auxiliary power unit being supported on said first frame;
(c) a second frame mounted in a stationary position to a predetermined portion of such motor vehicle; and
(d) means coupled to said first and second frames for enabling movement of said first frame in a vertical plane relative to said second frame to isolate said auxiliary power unit from the effects of road shock and vibration.

2. The auxiliary power system, according to claim 1, wherein said first frame includes:
(a) a pair of vertically disposed side members, each having a predetermined shape and an inwardly and horizontally disposed bottom flange, wherein said auxiliary power unit is mounted thereon;
(b) a first cross member secured at each end thereof to a respective top end of said each side member; and
(c) a second cross member secured at each end thereof to a respective side member intermediate ends thereof.

3. The auxiliary power system, according to claim 1, wherein said second frame includes:
(a) a pair of side members each having a first vertically disposed portion thereof positioned in abutting engagement with such predetermined portion of such motor vehicle and a second vertically disposed portion extending outwardly and generally perpendicular therefrom; and
(b) a cross member rigidly secured at each end thereof to a respective side member intermediate ends thereof.

4. The auxiliary power system, according to claim 3, wherein said second frame further includes a pair of stops secured to said cross member.

5. The auxiliary power system, according to claim 3, wherein said system includes a pair of isolation mounts secured to said cross member.

6. The auxiliary power system, according to claim 3, wherein said second frame is disposed within said first frame and wherein a portion of said each side member of said first frame is disposed coplanar with said second vertically disposed portion of said second frame.

7. The auxiliary power system, according to claim 1, wherein said isolating means includes a pair of spring elements each operable in a vertical direction and having a first end thereof pivotally connected to one side member of said first frame and having a second end thereof pivotally connected to a respectively positioned side member of said second frame.

8. The auxiliary power system, according to claim 7, wherein said spring element is an air spring.

9. The auxiliary power system, according to claim 7, wherein said spring element is a shock absorber.

10. The auxiliary power system, according to claim 1, wherein said isolating means further includes a plurality of isolation mounts for isolating said second frame from said first frame.

11. The auxiliary power system, according to claim 1, wherein said systems includes means disposed intermediate said auxiliary power unit and said first frame for isolating said first frame from noise and vibration generated by said auxiliary power unit during operation thereof.

12. The auxiliary power system, according to claim 11, wherein said noise and vibration isolating means includes a base plate and a plurality of isolation mounts.

13. The auxiliary power system, according to claim 12, wherein each of said plurality of isolation mounts is an elastomeric isolation mount.

14. The auxiliary power system, according to claim 11, wherein said noise and vibration isolating means includes a plurality of isolation mounts.

15. In combination with an auxiliary power unit capable of generating electrical power and providing cooling and heating environmental effects to operator of a motor vehicle, a frame assembly for isolating said auxiliary power unit from the effects of road shock and vibration, said frame assembly comprising:
(a) a first frame including:
i. a pair of vertically disposed side members, each having a predetermined shape and horizontally disposed flange,
ii. a first cross member secured at each end thereof to a respective top end of said each side member, and
iii. a second cross member secured at each end thereof to a respective side member intermediate ends thereof;
(b) a base plate, wherein said auxiliary powered unit is affixed to said base plate;
(c) a plurality of elastomeric isolation mounts for attaching said base plate to each flange;
(d) a second frame including:
i. a pair of side members each having a first vertically disposed portion thereof positioned in abutting engagement with a longitudinal rail of said vehicle and a second vertically disposed portion extending outwardly from and generally perpendicular thereto,
ii. a pair of apertures formed through said first vertical portion and spaced in a vertical direction for enabling attachment of said second frame to said longitudinal rail with fasteners, and
iii. a cross member rigidly secured at each end thereof to a respective side member of said second frame intermediate ends thereof;
(e) a pair of spring elements each operable in a vertical direction and having a first end thereof pivotally connected to a respective side member of said first frame and having a second end thereof pivotally connected to a respective side member of said second frame, whereby said first frame is mounted for pivotal movement in a vertical plane relative to said second frame and relative to said longitudinal rail for isolating said auxiliary power unit from said effects of road shock and vibration; and
(f) a pair of elastomeric isolation mounts operably secured to said cross member of said second frame for abuttingly engaging said second cross member of said first frame and for aiding in isolating said auxiliary power unit from said effects of road shock and vibration.

16. An auxiliary power system for a vehicle, said auxiliary power system comprising:
(a) an auxiliary power unit capable of generating electrical power and providing cooling and heating environmental effects to operator and occupant of the vehicle; and
(b) a suspension means mounted to a single longitudinal rail of a vehicle frame and securely receiving said auxiliary power unit, whereby said auxiliary power unit is allowed to move in a vertical plane relative to the longitudinal rail of the vehicle for withstanding effects of road shock and vibration.

17. The auxiliary power system employing an auxiliary power unit, according to claim 16, wherein said suspension means includes:
(a) a first frame, wherein the auxiliary power unit is mounted thereon;
(b) a second frame affixed in a stationary position to a single longitudinal rail of a vehicle frame; and
(c) means coupled to said first and second frames for enabling movement of said first frame in a vertical plane relative to said second frame to isolate said auxiliary power unit from the effects of road shock and vibration.
